(19) United States
(12) Patent Application Publication
(10) Pub. No.: US 2008/0224668 A1
(43) Pub. Date: Sep. 18, 2008

(54) Generator Device for Independently Charging At Least Two Batteries

(76) Inventor: Klaus Christ, Hofheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/064,884

(22) PCT Filed: Aug. 15, 2006
(86) PCT No.: PCT/EP06/65320

§ 371 Date: Feb. 26, 2008

(30) Foreign Application Priority Data
Sep. 2, 2005 (DE) 10 2005 042 010.9

(51) Int. Cl. H02J 7/04; H02J 7/00

(52) U.S. Cl. 320/162; 320/137

(57) ABSTRACT

A generator device, e.g. a motor vehicle alternator, has a generator and can be electrically coupled to at least two batteries at the output end. The generator device is provided with one respective rectifier circuit for the at least two batteries. The rectifier circuits are configured and can be controlled such that power generated by the generator can be fed to the respective battery independently of the at least one other battery.

### CROSS-REFERENCE TO RELATED APPLICATION

This application is a U.S. national stage application of International Application No. PCT/EP2006/065320 filed Aug. 15, 2006, which designates the United States of America, and claims priority to German Application number 10 2005 042 010.9 filed Sep. 2, 2005, the contents of which are hereby incorporated by reference in their entirety.

### TECHNICAL FIELD

The invention relates to a generator apparatus, for example an alternator in a motor vehicle, for mutually independent charging of at least two batteries.

### BACKGROUND

In a motor vehicle, a battery is provided in order to supply, for example, motor vehicle electronics or motor vehicle lighting with electrical power, or for starting an internal combustion engine in the motor vehicle. The generator apparatus is coupled to the internal combustion engine such that the generator apparatus is driven by the internal combustion engine. An AC voltage which is produced by the drive in a generator in the generator apparatus is rectified by a rectifier circuit and is supplied to the battery, in order to charge it. However, for example as a result of intensive use of the vehicle lighting, the battery may be discharged to such an extent that the internal combustion engine can no longer be started.

### SUMMARY

A simple generator apparatus for mutually independent charging of at least two batteries can be provided according to an embodiment, by a generator apparatus for mutually independent charging of at least two batteries, comprising a generator which can be electrically coupled on the output side to the at least two batteries, and comprising a rectifier circuit for each of the at least two batteries, wherein the rectifier circuits are each designed and can be controlled such that the respective battery can be supplied with power produced by the generator independently of the at least one other battery.

According to a further embodiment, each rectifier circuit in each case may have at least one thyristor which is in each case electrically arranged between the generator and the respective battery. According to a further embodiment, the generator apparatus may comprise for each rectifier circuit a measurement device electrically between the respective rectifier circuit and the respective battery which detects a variable which is representative of an instantaneous electrical charging current which is being supplied to the respective battery by the generator apparatus, and which variable is supplied to a control unit which is designed to control the respective rectifier circuit as a function of that variable such that the respective battery is charged with a respectively predetermined charging current. According to a further embodiment, the measurement device can be a measurement resistor, and the variable is a voltage drop across the measurement resistor.

### BRIEF DESCRIPTION OF THE DRAWINGS

Exemplary embodiments of the invention will be explained in the following text with reference to schematic drawings, in which:

FIG. 1 shows a first embodiment of a generator apparatus which is coupled to two batteries and a control unit, and

FIG. 2 shows a second embodiment of the generator apparatus.

Elements of the same design or with the same function are provided with the same reference symbols throughout the figures.

### DETAILED DESCRIPTION

According to an embodiment, a generator apparatus for mutually independent charging of at least two batteries, may have a generator and can be electrically coupled on the output side to the at least two batteries. The generator apparatus may have a rectifier circuit for each of the at least two batteries, which rectifier circuits are each designed and can be controlled such that the respective battery can be supplied with power produced by the generator independently of the at least one other battery in each case.

This has the advantage that the generator apparatus, for example an alternator in a motor vehicle, can charge in a preferred manner a battery which is provided for a motor-vehicle starting process. This allows a sufficiently large amount of energy to be provided for a subsequent process of starting the internal combustion engine even when the time for which the internal combustion engine is operated after starting is too short to recharge the at least two batteries. The at least two batteries can likewise be reliably charged when they have different states of charge to one another. Furthermore, a rectifier circuit can very easily be provided for each of the at least two batteries.

According to an embodiment of the generator apparatus, each rectifier circuit in each case has at least one thyristor which is in each case electrically arranged between the generator and the respective battery. The advantage is that the rectifier circuit can in this way be controlled very easily. Furthermore, the thyristor can very easily replace a rectifier diode which may be provided in the rectifier circuit. The thyristor can have a low on-state resistance. In consequence, losses can be kept low.

In a further embodiment of the generator apparatus, a measurement device is in each case provided electrically between the respective rectifier circuit and the respective battery and can in each case detect a variable which is representative of instantaneous electrical charging current which is being supplied to the respective battery by the generator apparatus. The variable can be supplied to a control unit which is designed to control the respective rectifier circuit as a function of that variable such that the respective battery is charged with a respectively predetermined charging current. The advantage is that the charging current for the respective battery can be regulated. This allows the respective battery to be charged with an appropriate charging current, so that the respective battery is reliably charged. Furthermore, this means that the generator apparatus is very simple.

In this context, it may be advantageous for the measurement device to be a measurement resistor, and for the variable to be a voltage drop across the measurement resistor. The advantage is that this is very simple and costs little.

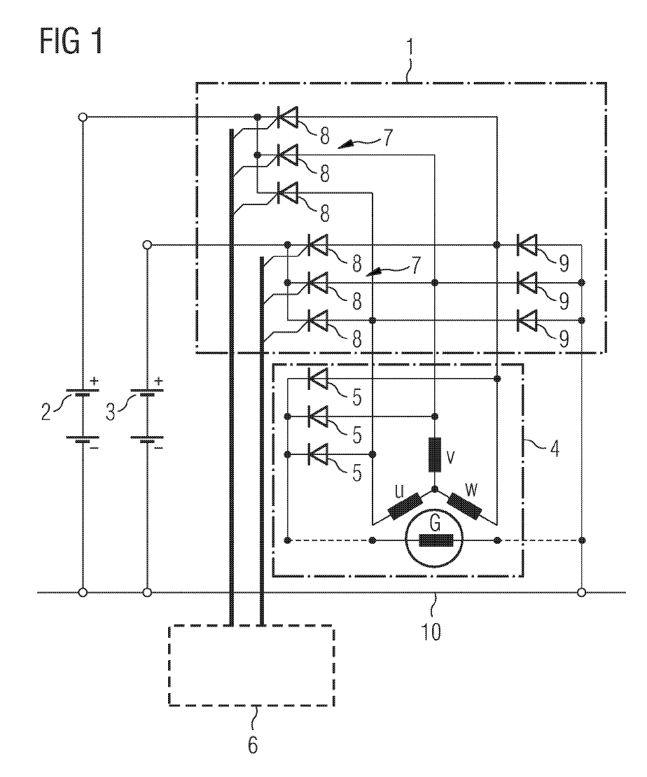

A generator apparatus, for example an alternator in a motor vehicle has a generator 4 and a rectifier unit 1 (FIG. 1). The generator 4 is a three-phase alternator with three phases winding u, v, w and an excitation winding G. Furthermore, excitation diodes 5 may be provided and each electrically coupled one phase winding u, v, w and the excitation winding G to one another. However the generator 4 may be in a different form as well.

The generator 4 is electrically coupled to the rectifier unit 1, and the rectifier unit 1 is coupled to a first battery 2 and to a second battery 3. When the generator 4 is driven, for example by an internal combustion engine in the motor vehicle, the electrical AC voltage produced by it is supplied to the rectifier unit 1. The rectifier unit 1 is designed to rectify the AC voltage supplied to it. The DC voltage produced from the AC voltage by the rectifier unit 1 can be supplied to the first battery 2 or to the second battery 3.

The rectifier unit 1 in each case has a rectifier circuit 7 for the first battery 2 and for the second battery 3, and these rectifier circuits 7 each have a thyristor 8 for each phase winding u, v, w of the generator 4. Each thyristor 8 is electrically arranged between the generator 4 and the first battery 2 or the second battery 3. The rectifier unit 1 also has a rectifier diode 9 in each case for each phase winding u, v, w of the generator 4, and these rectifier diodes 9 are arranged electrically between the generator 4 and a ground potential 10.

The rectifier unit 1 can be coupled to a control unit 6. The control unit 6 is designed to control the thyristor 8 in each of the rectifier circuits 7 such that the first battery 2 and/or the second battery 3 are/is supplied with a respectively predetermined amount of energy. The thyristors 8 can be controlled such that the first battery 2 and the second battery 3 can be charged independently of one another.

By way of example, the respective thyristor 8 may be controlled such that each thyristor 8 is in each case triggered such that it is switched on for at least one half-cycle of the AC voltage that is produced by the generator 4. The amount of energy is supplied to the first and to the second battery 2, 3 can then be controlled, for example by a respective number of half-cycles for which the respective thyristors 8 associated with the first battery 2 and the second battery 3 are switched on within a predetermined time period. However, for example, it is likewise possible to supply the respectively desired amount of energy to the first battery 2 and/or to the second battery 3 by phase-gating control of the respective thyristor 8. The amount of energy which is supplied to the first battery 2 and/or to the second battery 3 can then be controlled via the respective phase.

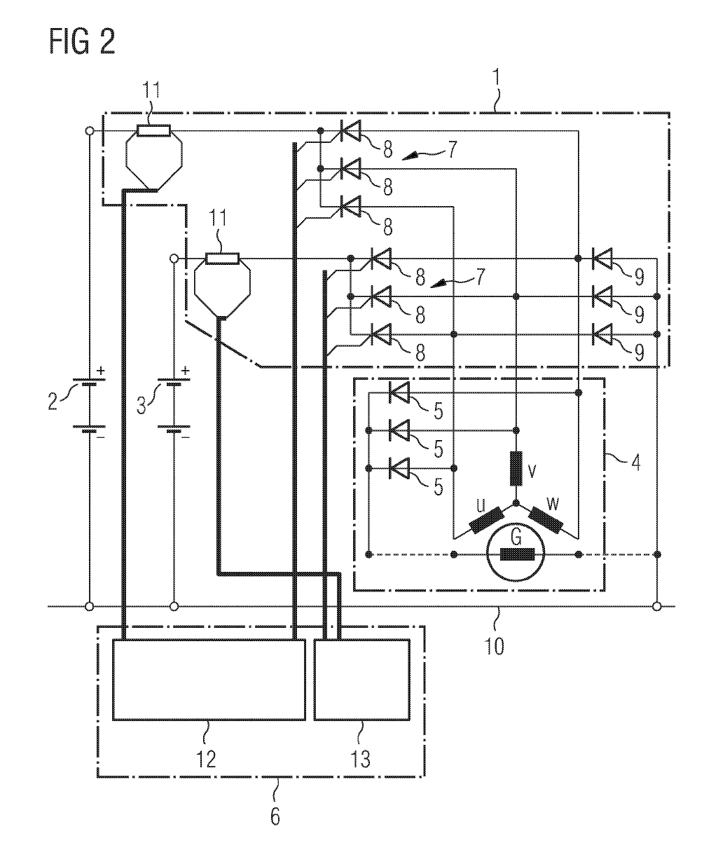

FIG. 2 shows a second embodiment of the generator apparatus. A measurement device, for example a measurement resistor 11, is provided electrically between each of the respective rectifier circuits 7 and the first battery 2 or the second battery 3. The respective measurement device is designed to produce a variable which is representative of an instantaneous electrical charging current which is being supplied to the respective battery by the generator apparatus. By way of example, the variable is a voltage drop across the respective measurement resistor 11. This voltage drop across the respective measurement resistor 11 is supplied to the control unit 6. The control unit 6 preferably may have a first regulation unit 12 and a second regulation unit 13. The first regulation unit 12 is coupled to the measurement resistor 11 and to the rectifier circuit 7 which is associated with the first battery 2. The second regulation unit 13 is coupled in a corresponding manner to the measurement resistor 11 and to the rectifier circuit 7 which is associated with the second battery 3. The first regulation unit 12 and the second regulation unit 13 are designed to control the respective thyristor 8 such that the first battery 2 and/or the second battery 3 are/is charged with a respectively predetermined charging current. This allows the first battery 2 and the second battery 3 to be charged independently of one another and if required at the same time, with the respectively predetermined charging current.

The generator apparatus and, in a corresponding manner, the control unit 6 may also be designed to charge more than two batteries independently of one another. The generator apparatus for this purpose has a rectifier circuit, which can be controlled by the control unit 6, for each battery. In a corresponding manner, a measurement device and a regulation unit can also be provided for each battery.

What is claimed is:

1. A generator apparatus for mutually independent charging of at least two batteries,
a generator which can be electrically coupled on the output side to the at least two batteries, and comprising a rectifier circuit for each of the at least two batteries, wherein the rectifier circuits are each designed and can be controlled such that the respective battery can be supplied with power produced by the generator independently of the at least one other battery.

2. The generator apparatus according to claim 1, wherein each rectifier circuit in each case has at least one thyristor which is in each case electrically arranged between the generator and the respective battery.

3. The generator apparatus according to claim 1, a measurement device electrically between the respective rectifier circuit and the respective battery which detects a variable which is representative of an instantaneous electrical charging current which is being supplied to the respective battery by the generator apparatus, and which variable is supplied to a control unit which is designed to control the respective rectifier circuit as a function of that variable such that the respective battery is charged with a respectively predetermined charging current.

4. The generator apparatus according to claim 3, wherein the measurement device is a measurement resistor, and the variable is a voltage drop across the measurement resistor.

5. An arrangement comprising:
at least two batteries,
a generator having an output electrically coupled to the at least two batteries,
at least two controllable rectifier circuits, wherein the rectifier circuits are controlled such that the respective battery is supplied with power produced by the generator independently of the at least one other battery.

6. The arrangement according to claim 5, wherein each rectifier circuit has at least one thyristor which is electrically arranged between the generator and the respective battery.

7. The arrangement according to claim 5, comprising for each rectifier circuit a measurement device electrically between the respective rectifier circuit and the respective battery which detects a variable which is representative of an instantaneous electrical charging current which is being supplied to the respective battery by the generator apparatus, and which variable is supplied to a control unit which is designed to control the respective rectifier circuit as a function of that variable such that the respective battery is charged with a respectively predetermined charging current.

8. The arrangement according to claim 7, wherein the measurement device is a measurement resistor, and the variable is a voltage drop across the measurement resistor.

9. A method for charging at least two batteries electrically coupled to a generator, the method comprising the steps of:
providing at least two controllable rectifier circuits, and
controlling the rectifier circuits such that the respective battery is supplied with power produced by the generator independently of the at least one other battery.

10. The method to claim 9, wherein each rectifier circuit has at least one thyristor which is electrically arranged between the generator and the respective battery.

11. The method to claim 9, comprising the step of measuring for each rectifier circuit a variable which is representative of an instantaneous electrical charging current which is being supplied to the respective battery by the generator apparatus, and
supplying the variable to a control unit for controlling the respective rectifier circuit as a function of that variable such that the respective battery is charged with a respectively predetermined charging current.

12. The method to claim 11, wherein the measurement device is a measurement resistor, and the variable is a voltage drop across the measurement resistor.
